(19) United States
(12) Patent Application Publication
(10) Pub. No.: US 2010/0206684 A1
(43) Pub. Date: Aug. 19, 2010

(54) METHOD FOR PRODUCING FIBRIL-EXHIBITING HIGH-PERFORMANCE CHOPPED FIBERS, FIBRIL-EXHIBITING HIGH-PERFORMANCE CHOPPED FIBERS, AND ARTICLES CONTAINING THE SAME

(75) Inventors: Michael Schmitt, Mettmann (DE); Gerald Ortlepp, Uhlstadt-Kirchhasel (DE)

Correspondence Address: OLIFF & BERRIDGE, PLC, P.O. BOX 320850, ALEXANDRIA, VA, 22320-4850, US

(73) Assignee: Teijin Aramid GmbH, Wuppertal (DE)

(21) Appl. No.: 12/734,070

(22) PCT Filed: Oct. 9, 2008
(86) PCT No.: PCT/EP2008/063512

§ 371 Date: Apr. 8, 2010

(30) Foreign Application Priority Data
Oct. 17, 2007 (EP) 07020274.2

(51) Int. Cl. F16D 13/60; B26D 7/08

(52) U.S. Cl. 192/107 M; 264/136; 428/364; 83/14

(57) ABSTRACT

A method for producing fibril-exhibiting high-performance fibers comprising the steps
a) providing an organic, high-performance filament yarn having a breaking tenacity of at least 10 g/dtex and a modulus of elasticity in extension of at least 150 g/dtex,
b) fibrillation of the high-performance filament yarn in a dry yarn state, through which a fibril-exhibiting high-performance filament yarn results, and
c) cutting the fibril-exhibiting high-performance filament yarn resulting from step b) into fibril-exhibiting high-performance chopped fibers of substantially the same length,
fibril-exhibiting high-performance chopped fibers of substantially the same length, an article comprising said fibers and one or more fillers, and a method for producing such an article are presented.

### BACKGROUND

The present invention relates to a method for producing fibril-exhibiting high-performance chopped fibers, to fibril-exhibiting high-performance chopped fibers, and to articles containing the same.

High-performance fibers, i.e. fibers with a high breaking tenacity and a high modulus of elasticity in extension, such as fibers made from aramid, polyolefin, polybenzoxazole, or polybenzthiazole are used, as is generally known, as reinforcing fibers in a plurality of articles, e.g. in friction linings. In particular, when using high-performance fibers as reinforcing fibers in friction linings, a high filler retention is required from the high-performance fibers.

The demand for high filler retention is met by pulped high-performance fibers, e.g. by aramid pulp, which has a filler retention measured with kaolin of approximately 80%.

However, pulping the high-performance fibers, that is

cutting the fibers,

producing a suspension from the cut fibers,

refining the cut fibers, implemented multiple times as necessary,

drying the refined fibers, and

compressing the dried fibers

represents a labor and energy intensive method which is correspondingly cost intensive.

US 2003/0022961 A1 describes a friction material which contains inter alia a mixture comprising a dry aramid pulp with at least one member selected from the group consisting of a wet aramid pulp, a wood pulp, and an acrylic pulp. To produce the dry aramid pulp, aramid fibers are provided, cut to a length of 13 mm, milled, and sieved. Milling takes place by shearing the chopped fibers between a rotating and a fixed cutting device such that the chopped fibers are not only pulped by the milling but are also cut additional times, by which means the stock length of practically all resulting pulp fibers is shorter than the cut length of the chopped fibers prior to the milling. However, the sieves tend to clog during operating, such that the method described in US 2003/0022961 A1 for preparing, cutting, milling, and sieving is interrupted after a certain time period and the clogged sieve has to be exchanged or made usable again. Consequently, the method described in US 2003/0022961 A1 for preparing, cutting, milling, and sieving is not suitable for continuous operation.

### SUMMARY

Therefore the present invention has the object of providing a method that is less labor and energy intensive, is additionally suited for continuous operation and despite that delivers a product that can be used as reinforcing fibers and processed into articles whose quality is at least no worse in comparison to the quality of articles produced in the same way but from pulp.

This object is achieved by a method for producing fibril-exhibiting high-performance fibers comprising the steps:

a) providing an organic, high-performance filament yarn having a breaking tenacity of at least 10 g/dtex and a modulus of elasticity in extension of at least 150 g/dtex,
b) fibrillation of the high-performance filament yarn in a dry yarn state, resulting in a fibril-exhibiting high-performance filament yarn, and
c) cutting the fibril-exhibiting high-performance filament yarn resulting from step b) into fibril-exhibiting high-performance chopped fibers of substantially the same length.

### DETAILED DESCRIPTION OF EMBODIMENTS

The comparison of the inventive method with the pulping method described at the beginning shows that the inventive method comprises a smaller number of steps which are easy to implement. In addition, the inventive method is significantly less energy intensive. This is especially the case because the steps required for the pulping method described in the beginning, involving refining (implemented multiple times as necessary) and drying, are omitted. Therefore the inventive method is significantly less expensive than the pulping method described in the beginning. In addition, the inventive method is suitable for continuous operation.

Nevertheless, the inventive method delivers fibril-exhibiting high-performance chopped fibers of substantially the same length, from which articles can be produced in a manner known per se, said articles are not only equal in quality, at least with respect to abrasion, but are indeed superior to articles which were produced in the same way but using the corresponding pulp.

For example, a brake lining can be produced according to a standard formulation using the fibril-exhibiting high-performance chopped fibers of substantially the same length resulting from the inventive method which surprisingly shows abrasion, on the lining as well as on the disk, that is lower than the abrasion on a brake lining produced according to the same standard formulation; however, instead of the fibril-exhibiting high-performance chopped fibers of substantially the same length resulting from the inventive method, said brake lining contains aramid pulp. This result is even less predictable, because the fibril-exhibiting high-performance chopped fibers of substantially the same length resulting from the inventive method show a filler retention measured with kaolin which lies in the range from approximately 10% to approximately 40%, which is indeed higher than that for the aramid chopped fibers (approximately 4%), yet it is drastically lower than the filler retention of aramid pulp (approximately 80%).

In light of this low filler retention, in comparison to that of aramid pulp, it would already be surprising if the abrasion of the brake lining containing the fibril-exhibiting high-performance chopped fibers of substantially the same length resulting from the inventive method were only slightly higher than the abrasion of the corresponding brake lining containing aramid pulp. It would have been even more surprising if the abrasion of the brake lining containing the fibril-exhibiting high-performance chopped fibers of substantially the same length resulting from the inventive method were equally as low as the abrasion of the corresponding brake lining containing aramid pulp. Consequently, it must be especially surprising that the abrasion of the brake lining containing the fibril-exhibiting high-performance chopped fibers of substantially the same length resulting from the inventive method is even lower than the abrasion of the corresponding brake lining containing aramid pulp.

Within the context of the present invention, the term “fibrillation” means that the organic high-performance filament yarn provided in step a) of the inventive method is fed over a friction surface so that preferably longitudinal friction results.

Further, within the context of the present invention, the term “fibrils” means fibers that diverge from the filaments of the high-performance filament yarn and have a diameter that is only a fraction, e.g. only one-half to one-twentieth of the diameter of a filament, preferably only one-third to one-tenth of the diameter of a filament. Since, as previously mentioned, the high-performance filament yarn is fed over a friction surface such that preferably a longitudinal friction results, and the longitudinal friction occurs over the entire length of the high-performance filament yarn, the fibrils of the fibril-exhibiting high-performance filament yarn resulting from step b) can have a length that is on the order of the length of the high-performance filament yarn. However, the length of the fibrils is correspondingly shortened by the cutting that takes place in step c) of the inventive method, which results in fibril-exhibiting high-performance chopped fibers of substantially the same length, from which fibers fibrils diverge, and which also results in fibrils that are present detached from the high-performance chopped fibers of substantially the same length.

The fibrillation of the high-performance filament yarn in step b) of the inventive method takes place in the dry yarn state. This means, in the context of the present invention, that the yarn has a water content that is established when the yarn is exposed to an atmosphere having a relative humidity of at most 90%, preferably at most 60% and particularly preferably at most 50%.

For the provision of the high-performance filament yarn in step a) of the inventive method, all organic filament yarns are suitable that have a breaking tenacity of at least 10 g/dtex and modulus of elasticity in extension of at least 150 g/dtex.

Within the context of the present invention, “high-performance filament yarn” means a yarn having the previously stated characteristics, wherein the filaments of the yarn preferably have a circular cross-section perpendicular to their length. However, yarns having another cross-sectional shape can also be used, such as an elliptical or trilobal, tetralobal, or multilobal cross-sectional shape.

Preferably, in step a) of the inventive method, a high-performance filament yarn is provided that is selected from one or more members of the groups comprising aramid filament yarns, polyolefin filament yarns, polybenzoxazole filament yarns and polybenzthiazole filament yarns.

This means that the high-performance filament yarn provided in step a) of the inventive method comprises e.g. only one of the filament yarns mentioned. However, the filament yarn provided in step a) of the inventive method can also comprise two or more of the filament yarns mentioned. Further, in step a) of the inventive method, a high-performance filament yarn can be provided that comprises a mixture of aramid filaments and/or polyolefin filaments and/or polybenzoxazole filaments and/or polybenzthiazole filaments.

Within the context of the present invention, “aramid filament yarns” means filament yarns made from an aromatic polyamide, of which at least 85% of the amide bonds (—CO—NH—) are attached directly to two aromatic rings. An aromatic polyamide that is especially preferred for the present invention is polyparaphenylene terephthalamide, a homopolymer resulting from the mole-for-mole polymerization of paraphenylene diamine and terephthaloyl dichloride. In addition, copolymers are suitable as aromatic polyamides for the present invention that contain, in addition to paraphenylene diamine and terephthaloyl dichloride, minor amounts of other diamines and/or other dicarboxylic acid chlorides embedded in the polymer chain. As a general rule it is understood that, in relation to paraphenylene diamine and terephthaloyl dichloride, the other diamines and/or other dicarboxylic acid chlorides can be incorporated in the polymer chain at an amount of up to 10 mole percent.

Within the context of the present invention, “polyolefin filament yarns” means yarns made from polyethylene or polypropylene. Thereby, “polyethylene” is understood to be a substantially linear polyethylene material, which has a molecular weight preferably greater than one million and can include minor amounts of chain branchings or of comonomers, whereby a “minor amount” is understood to mean that for every 100 carbon atoms in the primary chain, no more than 5 chain branchings or comonomers are present. The linear polyethylene material can additionally contain up to 50 wt. % of one or more polymer additives, such as alkene-1 polymers, in particular, low-pressure polyethylene, low-pressure polypropylene and the like; or low-molecular additives such as antioxidants, UV absorbers, dyes and the like, which are usually incorporated. A polyethylene material of this type is known under the designation “extended chain polyethylene” (ECPE). Within the context of the present invention, “polypropylene” is understood to be a substantially linear polypropylene, having a molecular weight of preferably more than one million.

Within the context of the present invention, “polybenzoxazoles” and “polybenzthiazoles” are understood to be polymers having the structural units presented in the following, whereby the aromatic groups attached to the nitrogen are preferably carbocyclic, as shown in the structural units. However, said groups can also be heterocyclic. In addition, the aromatic groups attached to the nitrogen are preferably six-membered rings, as shown in the structural units. However, said groups can also be formed as fused or unfused polycyclic systems.

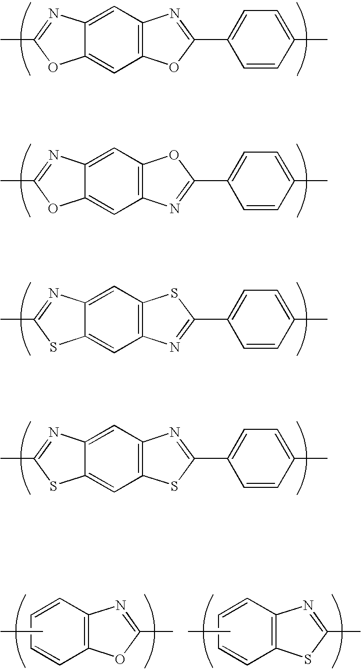

The high-performance filament yarn provided in step a) of the inventive method preferably has a yarn count in the range of 200 dtex to 7000 dtex, especially preferably in the range from 400 dtex to 4000 dtex.

In step a) of the inventive method, a high-performance filament yarn is provided that preferably has a filament linear density in the range of 0.2 dtex to 6.0 dtex, especially preferably in the range from 0.5 dtex to 2.5 dtex.

The provision of the high-performance filament yarn in step a) of the inventive method can occur in several ways. Especially simple and therefore preferred, the provision of the high-performance filament yarn in step a) of the inventive method is effected by unwinding the high-performance filament yarn from a spool or from a creel.

In a further preferred embodiment of the inventive method, the high-performance filament yarn is provided in step a) at a suitable point in the spinning process, wherein the actual high-performance filament yarn is produced. For this, in general each point of the actual spinning process is suitable at which the high-performance filament yarn

already has the values required for the inventive method of breaking tenacity of at least 10 g/dtex and modulus of elasticity in extension of at least 150 g/dtex and

is in a dry yarn state, which is required for the fibrillation occurring in the subsequent step b) of the inventive method.

In a melt-spinning process, as e.g. during the spinning of polyolefin filament yarn, this point can occur where the yarn leaves the stretching unit. In a wet-spinning process, as e.g. during the spinning of aramid filament yarn, the point can occur where the yarn is in a dry yarn state. Subsequently, the yarn is fibrillated in the dry yarn state online in step b) of the inventive method and is cut into fibril-exhibiting high-performance chopped fibers of substantially the same length in step c) of the inventive method.

In each case, i.e. regardless of whether a dry or wet-spinning process is involved, an integration of the inventive method in the spinning process wherein the actual high-performance filament yarn is produced results in fibril-exhibiting high-performance chopped fibers of substantially the same length. By this means, the otherwise necessary winding up at the conclusion of the spinning method is omitted.

Thus, the integration of the inventive method into the spinning process allows not only the substitution of the inventive method, which is simpler to implement and is less energy intensive, for the energy and labor intensive pulping method described at the beginning, but also the omission of the otherwise necessary winding up. As a result of the latter, the otherwise necessary effort for

quality control of the spools,

storage or shipping of the spools, and

setting-up the spools for the otherwise usual pulping process

is completely omitted. In fact, fibril-exhibiting high-performance chopped fibers of substantially the same length are available as the end product of the inventive method integrated into a conventional spinning process, which fibers can be immediately processed into articles that depend on tribological characteristics, like brake linings.

In step b) of the inventive method, the high-performance filament yarn is fibrillated. The fibrillation of the yarn is effected in that the yarn—preferably in the longitudinal direction—undergoes abrasion. The abrasion is effected in that the yarn is fed over a friction surface of any type, e.g. over a flat, curved, or looped friction surface, wherein good contact is arranged between the yarn and friction surface at the same time.

As a flat friction surface, e.g. a thread brake is a possibility in a simple embodiment.

As a curved friction surface, e.g. a cylinder is a possibility in a simple embodiment.

The intensity of the fibrillation, caused by feeding the high-performance filament yarn over the friction surface under tension, is expressed by the frequency and the length of the fibrils per unit of yarn length, and is dependent on the coefficient of friction of the friction surface and the applied tension. To achieve a high intensity of fibrillation, it is especially advantageous when the high-performance filament yarn has a high yarn count and comprises very many filaments, to bring the individual filaments of the yarn into a configuration prior to fibrillation in which the greatest possible number of filaments lie on the surface of the yarn, e.g. by spreading the yarn. This is accomplished in a simple way by guiding the high-performance filament yarn over a curved friction surface.

In each case, the fibrillation of the high-performance filament yarn that occurs in step b) of the inventive method can, in principle, be implemented with any device that leads to the fibril-exhibiting high-performance filament yarn. Of the devices that come into consideration for the fibrillation, such devices are preferably used in step b) of the inventive method that unite sufficient fibrillation intensity with a simple procedure.

Therefore, in a preferred embodiment of the inventive method, the fibrillation in step b) is implemented using a conventional disk friction device having friction disks, such as are used for false twist texturing of yarns, wherein, however, in the inventive method the rotational speed of the friction disks is <2000 rpm, preferably <1000 rpm, more preferably <500 rpm, and more particularly preferably 1-200 rpm or 0 rpm, and wherein the friction disks are preferably equipped with a surface made from nickel carbide or nickel diamond.

It is especially preferred that the friction disks of the disk friction device are not driven during the fibrillation. In this case, depending on the unit, speed, and drawing-off tension, the rotational speed of the friction disks adjusts to a value in one of the ranges listed in the previous paragraph.

In a further preferred embodiment, in step b) of the inventive method, the high-performance filament yarn is drawn over the friction surface at a speed from 10 m/min to 2000 m/min.

In a further preferred embodiment of the inventive method, the fibrillation of the high-performance filament yarn is implemented in step b) in two or more consecutive fibrillation steps b1), b2), . . . bn−1), and bn), wherein the steps b1), b2), . . . bn−1) prefibrillate the high-performance filament yarn and step bn) provides the yarn with the desired final fibrillation. The number n of the fibrillation steps is selected according to the difficulty with which the actual high-performance filament yarn can be fibrillated and corresponding to the desired final fibrillation. Therefore, this embodiment of the inventive method is especially advantageous when the high-performance filament yarn provided in step a) can only be fibrillated with difficulty and/or a high fibrillation intensity is desired. At the same time, the fibrillating effect of each fibrillation step b1), b2), . . . bn−1), and bn) can be set to be the same or different (the latter, e.g. by equipping the friction surfaces of the friction disks in the different fibrillation steps with different coarseness values of the friction surfaces or by a difference in the number and arrangement of the friction disks or by different contact forces resulting from the selection of different fiber tension when entering into the fibrillation device), so that the desired final fibrillation can be set very precisely.

In step c) of the inventive method, the fibril-exhibiting high-performance filament yarn resulting from step b) is cut into fibril-exhibiting high-performance chopped fibers of substantially the same length. Basically any device is suitable for this that can cut fibril-exhibiting high-performance filament yarns into fibril-exhibiting high-performance chopped fibers having substantially the same length. For this purpose, e.g. mechanical or thermal devices are capable, so that the cutting in step c) of the inventive method can be carried out mechanically (e.g. using one or more cutting blades) or thermally (e.g. using laser beams).

The cutting in step c) of the inventive method takes place at an angle from the axis of the filaments other than 0°, preferably at an angle of 90°.

In step c) of the inventive method, the fibril-exhibiting high-performance filament yarn is cut into fibril-exhibiting high-performance chopped fibers of substantially the same length, which means, in the context of the present invention, that a certain cutting length L is set in millimeters on the device selected for the cutting, and the device is capable of generating chopped fibers having said length L, wherein said length, in the cutting length range of 0.5 to 60 mm, preferably has at most a percentage variation given in formula (1)

ΔLmax[%]=±(40−0.6·L) (1)

wherein L means the cutting length set at the cutting device in mm.

In a preferred embodiment of the inventive method, the substantially same length of the high-performance chopped fibers resulting from step c) lies in the range from 0.5 mm to 60 mm, especially preferred in the range of 1 mm to 20 mm, still more preferred in the range from 1 mm to 12 mm, and most especially preferred in the range from 1 mm to 6 mm.

In a further preferred embodiment of the inventive method, the fibril-exhibiting high-performance chopped fibers of substantially the same length resulting from step c) have a filler retention, measured with kaolin, from 8% to 40%, especially preferred from 10% to 30%.

The underlying object of the present invention is further achieved by fibril-exhibiting high-performance chopped fibers, which are obtained according to the inventive method, and are characterized in that the fibril-exhibiting high-performance chopped fibers have a length that is preset by a cutting length L set in a cutting device, such that all fibril-exhibiting high-performance chopped fibers have substantially the same length. Thereby, “fibril-exhibiting”, “high-performance chopped fibers”, and “substantially the same length” mean correspondingly the same as in the previously described inventive method.

In a preferred embodiment, the inventive fibril-exhibiting high-performance chopped fibers have a substantially equal length, which lies in the range from 0.5 mm to 60 mm, especially preferred in the range of 1 mm to 20 mm, still more preferred in the range from 1 mm to 12 mm, and most especially preferred in the range from 1 mm to 6 mm.

In a further preferred embodiment, the inventive fibril-exhibiting high-performance chopped fibers have a filler retention, measured with kaolin, in the range from 8% to 40%, especially preferred from 10% to 30%.

The characteristics of the fibril-exhibiting high-performance chopped fibers of substantially the same length resulting from the inventive method are also perceivable in an article that contains these fibers. Therefore, the underlying object of the present invention is further achieved by

a method for producing an article, wherein the method comprises the steps a) to c) of the previously described inventive method and comprises additionally step d), which consists in that the fibril-exhibiting high-performance chopped fibers of substantially the same length resulting from step c), with the addition of one or more fillers, are processed in a manner known per se into an article which contains these fibers.

In a preferred embodiment of the inventive method for producing the article, one or more pulps made from high-performance filament yarns are added in step d) along with the filler or fillers.

In addition, the underlying object of the present invention is achieved by an article containing fibril-exhibiting high-performance chopped fibers of substantially the same length and one or more fillers. Here as well the expressions “fibril-exhibiting”, “high-performance chopped fibers”, and “of substantially the same length” mean correspondingly the same as in the previously described inventive method.

In a preferred embodiment of the inventive article, the article comprises in addition one or more pulps made from high-performance chopped fibers.

The option according to which the article resulting from the inventive method or the inventive article can contain, in addition to the fibril-exhibiting high-performance chopped fibers of substantially the same length, one or more pulps made from high-performance filament yarns, means, within the context of the present invention, that in the stated articles in addition e.g. a pulp can be present that is made from one or a plurality of high-performance filament yarns of the same type (e.g. made from para-aramid pulp) or of different types (e.g. made from para-aramid pulp and from meta-aramid pulp or polyacrylonitrile pulp).

Further, the article resulting from the inventive method or the inventive article can also contain one or a plurality of pulps that are not produced from high-performance filament yarns, i.e. are produced from yarns having a breaking tenacity of less than 10 g/dtex and a modulus of elasticity in extension of less than 150 g/dtex, insofar as this does not impair the desired characteristics of said article.

In preferred embodiments of the inventive article and of the article resulting from the inventive method, the substantially the same length of the fibers lies in a range from 0.5 mm to 60 mm, especially preferred in the range of 1 mm to 20 mm, still more preferred in the range from 1 mm to 12 mm, and most especially preferred in the range from 1 mm to 6 mm.

In further preferred embodiments of the inventive article and of the article resulting from the inventive method, the proportion by weight of the fibers to the total weight of the article is 0.1% to 25%, especially preferred 0.5% to 10%.

Again, in further preferred embodiments of the inventive article and of the article resulting from the inventive method, the article is a friction lining, a clutch lining, or an article of this type that depends on tribological characteristics.

The invention will now be described in more detail in the following examples:

### EXAMPLES

### Example 1

### i) Provision of Fibrillated Para-Aramid Chopped Fibers of the Same Length

A para-aramid filament yarn of the type 1000 3360 dtex (2000 filaments; yarn count=3360 dtex) from Teijin Twaron is unwound from a spool, spread and drawn twice at a pretension of 70 cN/tex with a speed of 600 m/min and with a tractive force of 10 N through a conventional disk friction device (manufacturer: BARMAG AG; classification: FK6-32S-556Z, type 8E, with elastic fiber guide) having 8 friction disks of the type FK6-32-255, wherein a rotational speed of the non-driven friction disks of approximately 100 rpm is set by the fiber traction through the disk friction unit. In the previously mentioned disk friction device, the 8 friction disks are arranged on 3 axes, wherein 3 friction disks each are arranged on the first 2 axes and 2 friction disks are arranged on the third axis. The distance of the friction disks from each other on an axis is approximately 2 cm. The axes of the friction disks are arranged in such a way to one another that the friction disks are present in an arrangement offset from one another. The friction disks are equipped with a friction surface made from nickel carbide. After leaving the disk friction device, the fibril-exhibiting para-aramid filament yarn is cut to a length of 3.4 mm, using a PierreT G28L1 guillotine cutting machine equipped with a carbide guillotine blade edge and a sprocket having 45 teeth on the gear shaft A and a sprocket having 9 teeth on the gear shaft B, whereby fibril-exhibiting para-aramid chopped fibers of the same 3.4 mm length are obtained.

### ii) Determining the Kaolin Retention

For producing a homogeneous mixture made from 3 wt. % of the fibril-exhibiting chopped fibers produced according to i) and 97 wt. % of the filler kaolin, 90 g of the fibril-exhibiting fibers produced according to i) are mixed with 2910 g type MK1 kaolin (trade name, Kaolin Laude SP20, manufacturer: Heller GmbH, Wuppertal, Del.) in an MTI mixer (manufacturer: MTI-Mischtechnik International GmbH, Detmold, Del.) at 2300 rpm for 5 minutes. From the resulting homogeneous mixture, 20±0.1 g is weighed out on a sieve that has a mesh width of 0.25 mm. The sieve with the homogeneous mixture is vibrated in a vibratory screener, type JEL 200/80 (manufacturer: Engelsmann, Ludwigshafen, Del.) for 3 minutes in the horizontal direction. A part of the mixture falls though the sieve thereby, while another part of the mixture, i.e. the sieve residue, remains on the sieve. From the weight of the sieve residue SR, based on the weighed out 20 g of the previously described homogeneous kaolin/fiber mixture, the kaolin retention is calculated, according to (SR/20 g)·100(%). The kaolin retention of the fibrillated, 3.4 mm long para-aramid chopped fibers is 14.9%. This value is greater than the approximately 4% kaolin retention, determined in the same way, for non-fibrillated, 6.0 mm long, para-aramid chopped fibers, type Twaron 1080 and approximately the same as the 15.7% kaolin retention of the non-fibrillated, 3.4 mm long, para-aramid chopped fibers, type Twaron 1000 3360 (manufacturer: Teijin Twaron); however, it is significantly lower that the 80% kaolin retention, determined in the same way, of para-aramid pulp, type 1095 (manufacturer: Teijin Twaron).

### iii) Determining the Bulk Volume

30 g of the homogeneous kaolin/fiber mixture produced according to ii) is poured into a graduated cylinder and the bulk volume is calculated from the filling volume V according to V(ml)/30 g. The homogeneous mixture made from 3 wt. % of the fibril-exhibiting chopped fibers produced according to i) and 97 wt. % of the filler kaolin has a bulk volume of 3.99 ml/g. The bulk volume of a homogeneous mixture made from 3 wt. % para-aramid pulp, type 1095 (manufacturer: Teijin Twaron) and 97 wt. % of the filler kaolin is 3.37±0.3 ml/g, wherein ±0.3 ml/g represents the maximum deviation.

### iv) Determining the Impact Strength of Cold Pressings (“Green Strength”)

For producing a cold pressing, 20±0.1 g of the homogeneous mixture produced according to ii) made from 3 wt. % of the fibril-exhibiting para-aramid chopped fibers of a length of 3.4 mm produced according to i) and 97 wt. % of the kaolin are inserted into a pressing mold, and are converted, using 3 pressing cycles each comprising 30 seconds of pressing at a pressure of 70 bar and 10 seconds degassing, and a final pressing for 5 minutes at a pressure of 70 bar, into a cold pressing that has a length of 91 mm and, in the middle, a width b)=15 mm and a thickness d), which thickness is measured after the pressing and has a value that is not to fall below 7.5 mm and is not to exceed 11.00 mm. The cold pressing is deposited, centered and edge up, in the anvil of a pendulum impact tester, such as is shown in A. M. Wittfoht, “Kunststofftechnisches Wörterbuch, Teil 1” (Carl Hanser Verlag München, 1981), page 249, under “1st Charpy Method”, and the impact energy An is measured. The impact strength an is calculated from the impact energy An according to an=(An·98.1)/(b·d) [mJ/mm²].

The impact strength of a cold pressing is determined in the same way that contains para-aramid pulp, type 1095 (manufacturer: Teijin Twaron) instead of the fibril-exhibiting chopped fibers produced according to i). The impact strength of the cold pressing with the fibril-exhibiting chopped fibers produced according to i) is, at 1.75 mJ/mm², as high as the impact strength of a cold pressing made in the same way except with non-fibrillated, 6 mm long, para-aramid chopped fibers. The impact strength of a cold pressing produced in the same way except with para-aramid pulp, type 1095, is 1.09±0.35 mJ/mm².

### v) Producing a Friction Lining

Using the fibril-exhibiting para-aramid chopped fibers of a length of 3.4 mm produced according to i), a brake lining B1 was produced according to a standard formulation from Produco GmbH that is commercially used by manufacturers of brake linings.

### vi) Measuring Wear and Mean Friction Value

The wear and mean friction value of the friction lining produced according to v) were determined according to Specification J2522 of the SAE (Society of Automotive Engineers) published in June, 2003. The results are summarized in the following table.

### Example 2

Example 2 was realized using steps i) to vi) as in Example 1; however, with the difference that in step i) of Example 2, a para-aramid filament yarn, type 1000 1680 dtex (1000 filaments, yarn count=1680 dtex) was used. The wear and mean friction value of the brake lining B2 resulting in Example 2 are likewise shown in the following table.

### Comparison Example

For a comparison, the wear and mean friction value were measured for a comparison brake lining V, produced as under v) in Example 1 or 2, with the difference that a para-aramid pulp, type 1095, from Teijin Twaron was used instead of the fibril-exhibiting para-aramid chopped fibers of a length of 3.4 mm.

| | Brake | Wear on the | Wear on the | |
|---|---|---|---|---|
| | lining | lining [g] | disk [g] | Friction value |
| Example 1 | B1 | 13.0 | 8.1 | 0.43 |
| Example 2 | B2 | 13.0 | 8.1 | 0.43 |
| Comparison | V | 14.1 | 9.0 | 0.44 |
| Example | | | | |

The table shows that the brake linings B1 and B2 produced with the inventive fibril-exhibiting para-aramid chopped fibers of a length of 3.4 mm have a wear of the lining that, at a value of 13.0 g, is approximately 8% lower than the wear of the comparison brake lining that has a value of 14.1 g.

The table additionally shows that the brake linings B1 and B2 produced with the inventive fibril-exhibiting para-aramid chopped fibers of a length of 3.4 mm have a wear of the disk that, at a value of 8.1 g, is approximately 10% lower than the wear of the comparison brake lining, which was 9.0 g.

The table finally shows that the mean friction value of the brake linings B1 and B2, produced with the inventive fibril-exhibiting para-aramid chopped fibers of a length of 3.4 mm, has a value of 0.43, which lies within the range of 0.42 to 0.45 approved by the manufacturers of brakes, and is approximately the same as the mean friction value of the brake lining V, which is produced using p-aramid pulp.

1. A method for producing fibril-exhibiting high-performance fibers comprising the steps
a) providing an organic, high-performance filament yarn having a breaking tenacity of at least 10 g/dtex and a modulus of elasticity in extension of at least 150 g/dtex,
b) fibrillation of the high-performance filament yarn in a dry yarn state, wherein a fibril-exhibiting high-performance filament yarn results, and
c) cutting the fibril-exhibiting high-performance filament yarn resulting from step b) into fibril-exhibiting high-performance chopped fibers of substantially the same length.

2. A method according to claim 1, wherein in step a) a high-performance filament yarn is provided that is selected from one or more members of the groups comprising aramid filament yarns, polyolefin filament yarns, polybenzoxazole filament yarns and polybenzthiazole filament yarns.

3. A method according to claim 1, wherein the provision of the high-performance filament yarn in step a) is effected by unwinding the high-performance filament yarn from a spool or from a creel.

4. A method according to claim 1, wherein the fibrillation is implemented in step b) using a disk friction device with friction disks whose rotational speed is up to 2000 rpm.

5. A method according to claim 4, wherein the friction disks of the disk friction device are not driven.

6. A method according to claim 4, wherein the friction disks are equipped with a friction surface made from nickel carbide or nickel diamond.

7. A method according to claim 6, wherein the high-performance filament yarn is drawn at a speed from 10 m/min to 2000 m/min over the friction surface.

8. A method according to claim 1, wherein the cutting of the fibril-exhibiting high-performance filament yarn resulting from step b) is implemented mechanically in step c).

9. A method according to claim 1, wherein the cutting of the fibril-exhibiting high-performance filament yarn resulting from step b) is implemented thermally in step c).

10. A method according to claim 1, wherein the cutting is implemented in step c) such that fibril-exhibiting high-performance chopped fibers of substantially the same length result, said length being 0.5 mm to 60 mm.

11. Fibril-exhibiting high-performance chopped fibers, which are obtained according to claim 1, wherein the fibril-exhibiting high-performance chopped fibers have a length that is preset by a cutting length L set in a cutting device, such that all fibril-exhibiting high-performance chopped fibers have substantially the same length.

12. Fibril-exhibiting high-performance chopped fibers according to claim 11, wherein the substantially same length lies in the range from 0.5 mm to 60 mm.

13. Fibril-exhibiting high-performance chopped fibers according to claim 11, wherein the fibers have a filler retention, measured with kaolin, in the range from 8% to 40%.

14. A method for producing an article comprising steps a) to c) according to claim 1, and additionally d) processing the fibril-exhibiting high-performance chopped fibers of substantially the same length resulting from step c), with the addition of one or more fillers, in a manner known per se into an article which contains these fibers.

15. A method according to claim 14, wherein one or more pulps made from high-performance filament yarns are added in step d) along with the filler or fillers.

16. An article comprising fibril-exhibiting high-performance chopped fibers of substantially the same length according to claim 11 and one or more fillers.

17. An article according to claim 16, wherein the article comprises additionally one or more pulps made from high-performance chopped fibers.

18. An article according to claim 16, wherein the substantially same length of the fibers lies in the range from 0.5 mm to 60 mM.

19. An article according to claim 16, wherein the proportion by weight of the fibers to the total weight of the article is 0.1% to 25%.

20. An article according to claim 16, wherein the article is a friction lining or a clutch lining.
